(19) United States
(12) Patent Application Publication
(10) Pub. No.: US 2026/0158783 A1
(43) Pub. Date: Jun. 11, 2026

(54) LIQUID DISCHARGE HEAD AND LIQUID DISCHARGE APPARATUS

(71) Applicants: Shiomi ANDOH, Kanagawa (JP); Takashi MORI, Kanagawa (JP)

(72) Inventors: Shiomi ANDOH, Kanagawa (JP); Takashi MORI, Kanagawa (JP)

(21) Appl. No.: 19/370,775

(22) Filed: Oct. 28, 2025

(30) Foreign Application Priority Data
Dec. 6, 2024 (JP) 2024-213763

(51) Int. Cl. B41J 2/14

(52) U.S. Cl. CPC B41J 2/14274; B41J 2/1433

(57) ABSTRACT

A liquid discharge head includes a nozzle plate, a channel plate, multiple diaphragms, and an actuator element. The nozzle plate has multiple nozzles arrayed on a nozzle face in a longitudinal direction of the nozzle face. The multiple nozzles discharge a liquid in a discharge direction perpendicular to the nozzle face. The channel plate is disposed over the nozzle plate in the discharge direction. The channel plate has multiple pressure chambers respectively communicating with the multiple nozzles. The multiple diaphragms are disposed over the channel plate in the discharge direction. The multiple diaphragms respectively define wall portions of the multiple pressure chambers. The multiple diaphragms are arrayed in the longitudinal direction. The actuator element is disposed over the multiple diaphragms to vibrate the multiple diaphragms.

### CROSS-REFERENCE TO RELATED APPLICATION

This patent application is based on and claims priority pursuant to 35 U.S.C. § 119(a) to Japanese Patent Application No. 2024-213763, filed on Dec. 6, 2024, in the Japan Patent Office, the entire disclosure of which is hereby incorporated by reference herein.

### BACKGROUND

### Technical Field

The present disclosure relates to a liquid discharge head and a liquid discharge apparatus.

### Related Art

In the art, a liquid discharge head includes multiple nozzles arrayed in a head longitudinal direction, multiple pressure chambers respectively communicating with the multiple nozzles, a diaphragm forming wall portions of the multiple pressure chambers, and multiple actuator elements that drive (vibrate) the diaphragm. The actuator elements are arranged side by side in the head longitudinal direction.

### SUMMARY

A liquid discharge head includes a nozzle plate, a channel plate, multiple diaphragms, and an actuator element. The nozzle plate has multiple nozzles arrayed on a nozzle face in a longitudinal direction of the nozzle face. The multiple nozzles discharge a liquid in a discharge direction perpendicular to the nozzle face. The channel plate is disposed over the nozzle plate in the discharge direction. The channel plate has multiple pressure chambers respectively communicating with the multiple nozzles. The multiple diaphragms are disposed over the channel plate in the discharge direction. The multiple diaphragms respectively define wall portions of the multiple pressure chambers. The multiple diaphragms are arrayed in the longitudinal direction. The actuator element is disposed over the multiple diaphragms to vibrate the multiple diaphragms.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a cross-sectional view of a liquid discharge head orthogonal to a head transverse direction (Y direction);

FIG. 2 is a cross-sectional view of a liquid discharge head orthogonal to a head height direction (Z direction);

FIG. 3 is a cross-sectional view of a liquid discharge head orthogonal to a head longitudinal direction (X direction);

FIG. 4 is an enlarged view of the area surrounded by broken line X1 in FIG. 1;

FIG. 5 is an enlarged view of the area surrounded by broken line Y1 in FIG. 2;

FIGS. 6A and 6B are schematic views of a liquid discharge head in which two piezoelectric bodies are arrayed side by side in a head longitudinal direction;

FIG. 7 is a diagram illustrating the manufacturing of elongated diaphragms;

FIG. 8 is a diagram illustrating the manufacturing of shortened diaphragms;

FIGS. 9A and 9B are diagrams of diaphragms arrayed side by side in a head longitudinal direction according to a comparative example;

FIG. 10 is a cross-sectional view of a liquid discharge head according to an embodiment of the present disclosure, orthogonal to a head transverse direction (Y direction);

FIG. 11 is a cross-sectional view of the liquid discharge head of FIG. 10, orthogonal to a head height direction (Z direction);

FIG. 12 is an enlarged view of the area surrounded by broken line X2 in FIG. 10;

FIG. 13 is an enlarged view of the area surrounded by broken line Y2 in FIG. 11;

FIGS. 14A to 14C are diagrams each illustrating communication pipes according to a modification;

FIG. 15 is a perspective view of ink channels from pressure chambers to nozzles according to a modification;

FIG. 16 is a plan view of a part of a liquid discharge apparatus;

FIG. 17 is a side view of the part of the liquid discharge apparatus of FIG. 16;

FIG. 18 is a plan view of a part of a liquid discharge unit;

FIG. 19 is a front view of another liquid discharge unit; and

FIG. 20 is a schematic view of an electrode manufacturing apparatus.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

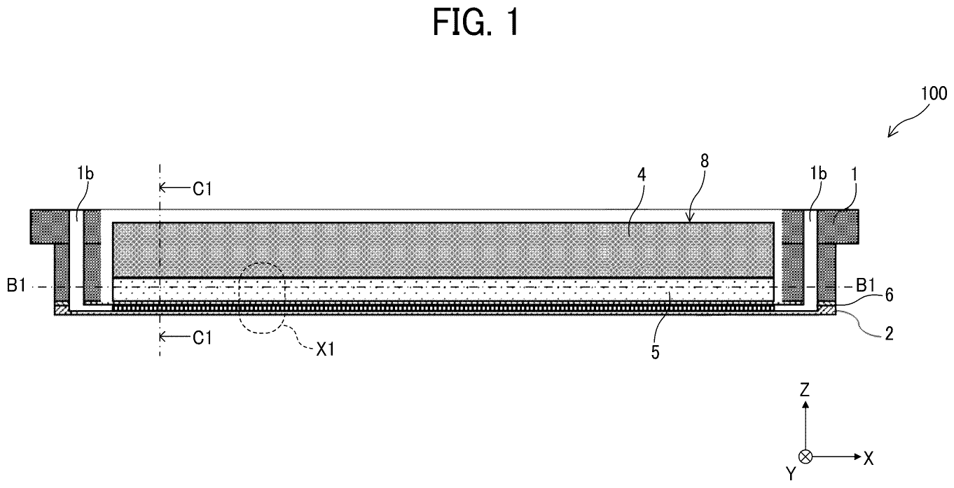

A liquid discharge head will be described below. A basic configuration of the liquid discharge head will be described below with reference to FIGS. 1 to 5.

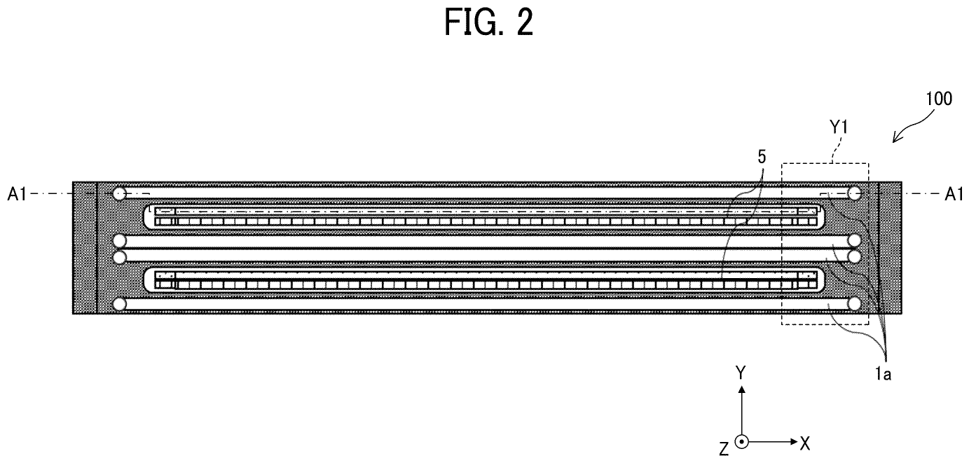

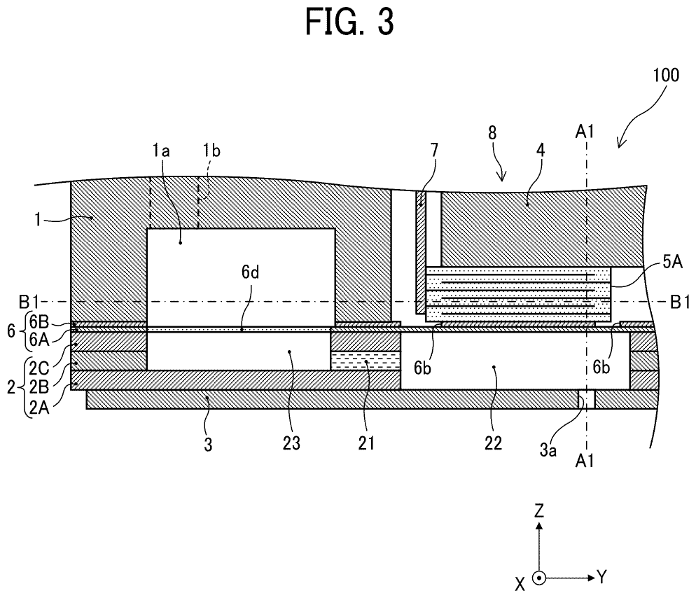

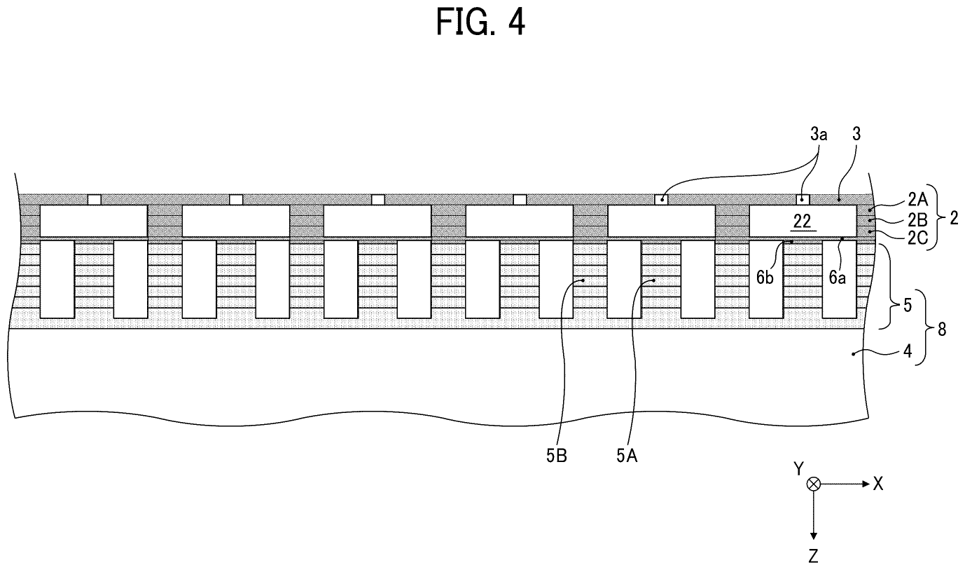

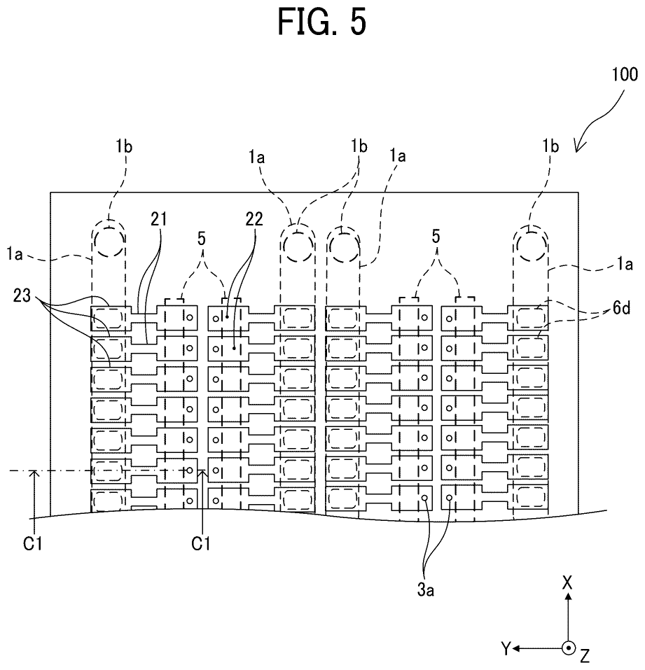

FIG. 1 is a cross-sectional view of the liquid discharge head taken along line A1-A1 in FIGS. 2 and 3. FIG. 2 is a cross-sectional view of the liquid discharge head taken along line B1-B1 in FIGS. 1 and 3. FIG. 3 is a cross-sectional view of the liquid discharge head taken along line C1-C1 in FIGS. 1 and 5. FIG. 4 is an enlarged view of the area surrounded by broken line X1 in FIG. 1. FIG. 5 is an enlarged view of the area surrounded by broken line Y1 in FIG. 2.

A liquid discharge head 100 includes a nozzle plate 3, a channel plate 2, and a diaphragm 6 made of a thin film, all of which are laminated one on another and joined to each other. The liquid discharge head 100 further includes a piezoelectric actuator 8 and a frame 1. The piezoelectric actuator 8 displaces the diaphragm 6. The channel plate 2 is disposed over the nozzle plate 3. The diaphragm 6 is disposed over the channel plate 2.

The nozzle plate 3 is made of a metal material, such as steel use stainless (SUS) material. The nozzle plate 3 has multiple nozzles 3a to discharge liquid. The multiple nozzles 3a in the nozzle plate 3 are arrayed on a nozzle face of the nozzle plate 3 in a head longitudinal direction (X direction) to form four nozzle rows, which are disposed at predetermined intervals in a head transverse direction (Y direction) orthogonal to the head longitudinal direction. The head longitudinal direction and the head transverse direction are the same as the longitudinal direction and the transverse direction of the nozzle face, respectively.

As illustrated in FIGS. 3 and 4, the channel plate 2 includes multiple (three in FIGS. 3 and 4) plate components 2A, 2B, and 2C laminated one on another in a thickness direction. Each of the plate components 2A, 2B, and 2C is formed of a metal material, such as a SUS material.

As illustrated in FIGS. 3 and 5, the channel plate 2 has pressure chambers 22, fluid restrictors 21, and guide channels 23, the number of each of which is the same as the number of nozzles 3a. The pressure chambers 22 communicate with the nozzles 3a, respectively. The fluid restrictors 21 communicate with the pressure chambers 22, respectively. The guide channels 23 communicate with the fluid restrictors 21, respectively.

Each of the plate components 2A, 2B, and 2C is processed by etching or pressing to form multiple through-holes corresponding to the pressure chambers 22, the fluid restrictors 21, and the guide channels 23. When the plate components 2A, 2B, and 2C are laminated one on another, the multiple pressure chambers 22, fluid restrictors 21, and guide channels 23 are formed by the multiple through-holes in the channel plate 2. The multiple fluid restrictors 21 are formed by the through-holes in the plate component 2B. In this case, portions of the plate components 2A, 2B, and 2C which have not been processed to form the through-holes in the height direction (Z direction) serve as partition walls between the pressure chamber 22 and the guide channel 23, between the pressure chambers 22, and between the guide channels 23.

The frame 1 is made of, for example, a SUS material. The SUS material is cut by machining to form common liquid chambers 1a and communication holes 1b communicating with the common liquid chambers 1a, respectively. Each common liquid chamber 1a communicates with the corresponding multiple guide channels 23.

The diaphragm 6 defines portions of the wall faces of the pressure chambers 22 in the channel plate 2 and the bottom faces of the common liquid chambers 1a. The diaphragm 6 has a two-layered structure including a first layer 6A and a second layer 6B. Alternatively, the diaphragm 6 may have a single-layered structure or a three or more layered structure. Portions of the first layer 6A defining the wall faces of the pressure chambers 22 on the channel plate 2 side are deformable diaphragm portions 6a. In addition, the first layer 6A is provided with openings 6d connecting the common liquid chambers 1a and the corresponding guide channels 23.

Ink as a liquid is introduced from the common liquid chambers 1a to the guide channels 23 via the openings 6d, and then the ink is supplied from the guide channels 23 to the pressure chambers 22 via the fluid restrictors 21. In this case, each opening 6d may be provided with a filter.

The piezoelectric actuator 8 is disposed on the side of the diaphragm 6 opposite to the pressure chambers 22 side. In other words, the piezoelectric actuator 6 including piezoelectric bodies 5 is disposed over the diaphragm 6. The Piezoelectric bodies 5 as actuator elements are bonded to a base 4 with an adhesive to form the piezoelectric actuator 8. Each piezoelectric body 5 has a comb shape in which a predetermined number of columnar piezoelectric elements 5A and 5B are arranged at predetermined intervals in the head longitudinal direction (X direction). A piezoelectric material bonded to the base 4 is grooved by half-cut dicing to form the comb shape in each piezoelectric body 5.

The piezoelectric elements 5A and 5B are made of the same material. As a drive waveform is applied, the piezoelectric element 5A (drive portion) is driven. On the other hand, a drive waveform is not applied to the piezoelectric element 5B (non-drive portion), and the piezoelectric element 5B merely serves as a support. The piezoelectric elements 5A are bonded to projections 6b. Each projection 6b is an island-shaped thick portion formed in the diaphragm portion 6a. The piezoelectric elements 5B are bonded to the projections 6b, which are the thick portions of the diaphragm 6.

The piezoelectric body 5 includes piezoelectric layers and internal electrodes, which are alternately laminated. Each piezoelectric layer is lead zirconate titanate (PZT) having a thickness of 10 to 50 μm. Each internal electrode is silver palladium (AgPd) having a thickness of several μm. The internal electrodes are extended to both side faces of the piezoelectric body 5 in a pressure chamber longitudinal direction and are connected to a common electrode and individual electrodes, which are side face electrodes (external electrodes).

The individual electrodes are multiple individual electrodes formed by dividing, with half-cutting dicing, an electrode on the outer face of the piezoelectric body 5. The length of the electrode on the outer face of the piezoelectric body 5 is regulated in advance by a process, such as a notching process. The common electrode is not separated into multiple electrodes by the dicing process and is conductive in this form.

A flexible printed circuit (FPC) 7 as a flexible wiring is connected to the individual electrodes with solder bonding. The common electrode is bonded to the ground (GND) electrodes of the FPC 7 via electrode layers on the piezoelectric bodies 5 (the electrode layers disposed around the side faces of the piezoelectric bodies 5). The FPC 7 is provided with a driver integrated circuit (IC). The driver IC controls a voltage applied to the piezoelectric elements 5A.

In the liquid discharge head 100 described above, drive waveforms (e.g., pulse voltages of 10 to 50 V) are applied to the piezoelectric elements 5A in accordance with a recording signal. In response, the piezoelectric element 5A is displaced in the lamination direction. The displacements of the piezoelectric elements 5A pressurize the ink in the corresponding pressure chambers 22 via the diaphragm 6. In response, the pressure of the ink in the pressure chamber 22 increases, and thus the droplets of the ink are discharged from the nozzles 3a. In other words, the piezoelectric body 5 (piezoelectric elements 5A) as an actuator element vibrates the diaphragm 6 to discharge a liquid (e.g., ink) in a discharge direction perpendicular to the nozzle face.

With the completion of the discharge of ink droplets, the ink pressure in the pressure chamber 22 decreases. Then, because of the inertia of the ink flow and the displacements of the piezoelectric elements 5A in the process of discharging the drive pulse, a negative pressure is generated and applied to the ink in the pressure chambers 22. As a result, an ink filling (ink refill) step starts. At this time, ink supplied from an external ink tank flows into the common liquid chamber 1a, passes through the guide channels 23 and the fluid restrictors 21 from the common liquid chamber 1a via the openings 6d, and enters the pressure chambers 22. As a result, the ink is supplied to the pressure chambers 6.

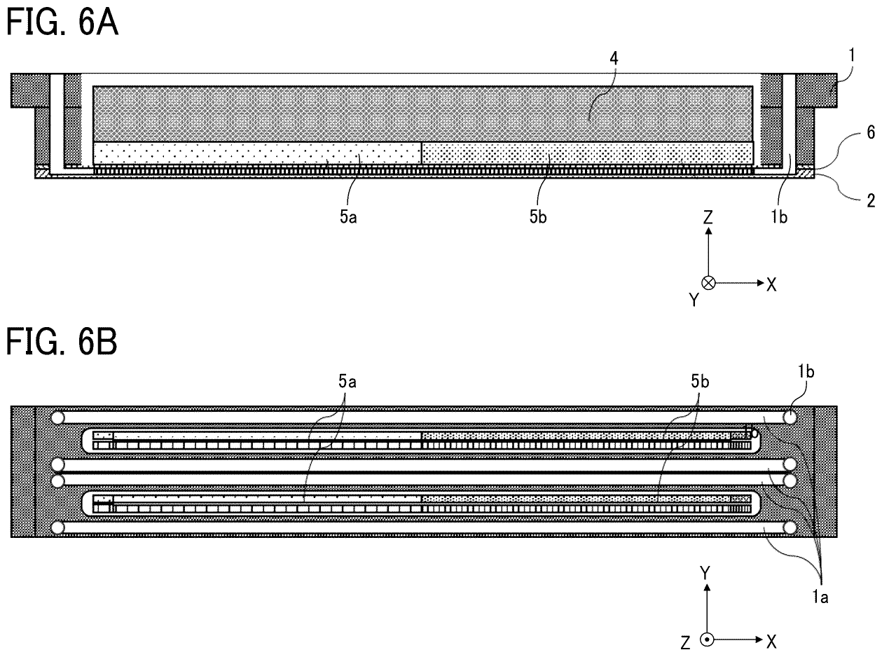

With growing demand for high-speed and high-resolution printing, an inkjet recording apparatus equipped with the liquid discharge head 100 preferably includes an elongated liquid discharge head and has a highly-dense arrangement of nozzles 3a. To manufacture an elongated liquid discharge head, long components are used as materials for the liquid discharge head. Such long components are difficult to manufacture with high accuracy, which may cause a cost increase. As illustrated in FIGS. 6A and 6B, multiple shortened piezoelectric bodies 5 (5a and 5b) may be arranged side by side in the head longitudinal direction (X direction). However, using such shortened piezoelectric bodies 5 may be insufficient to prevent the cost increase for elongating a liquid discharge head.

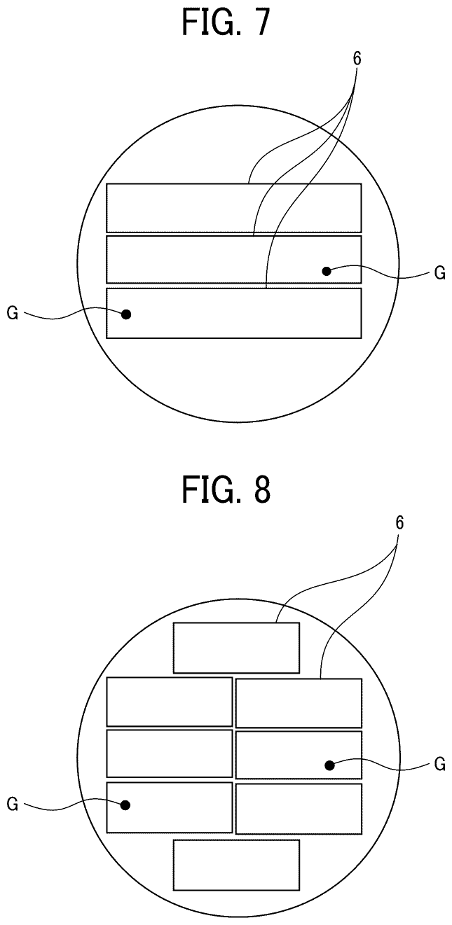

To manufacture the diaphragms 6, a wafer is etched to form the openings 6d, the projections 6b, and the diaphragm portions 6a therein. As the diaphragms 6 are elongated as illustrated in FIG. 7, the number of the diaphragms 6 to be obtained from a single wafer decreases. In this case, if some defective areas G are present in the wafer, as illustrated in FIG. 7, two out of three diaphragms 6 become defective, resulting in a low yield. In the case where the length of each diaphragm 6 in FIG. 7 is halved, as illustrated in FIG. 8, eight diaphragms 6 can be obtained from a single wafer.

In this case, even if the defective areas G are present at the same location as in FIG. 7, six good diaphragms 6 can be obtained, resulting in an increase in yield. By shortening the diaphragms 6, the manufacturing cost can be reduced.

However, if multiple shortened diaphragms 6 are arranged in the head longitudinal direction (X direction) to manufacture an elongated liquid discharge head, some disadvantages may arise. As described above, the diaphragm 6 defines the bottom face of the common liquid chamber 1a. Even when multiple shortened diaphragms 6 are seamlessly arrayed side by side in the head longitudinal direction (X direction), the ink inside the common liquid chamber 1a may leak to the outside via a gap between the diaphragms 6.

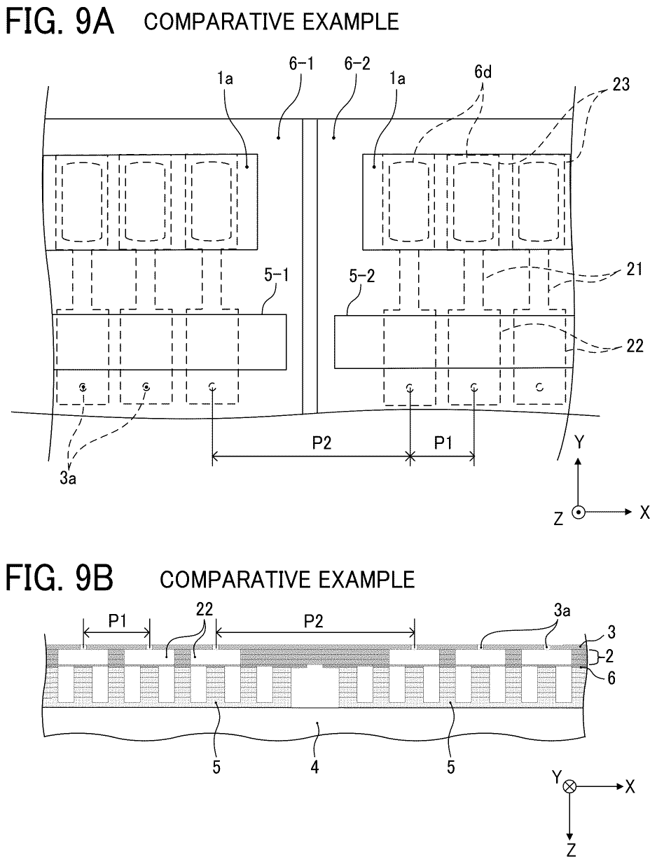

When multiple shortened diaphragms 6 (6-1 and 6-2) are arrayed side by side in the head longitudinal direction (X direction), as illustrated in FIG. 9A, the common liquid chamber 1a is divided into separated common liquid chambers 1a from each other at the location at which the diaphragms 6-1 and 6-2 are separated. Thus, multiple common liquid chambers 1a are also arrayed side by side in the head longitudinal direction (X direction). In such a configuration, the frame 1 is provided with a partition wall between the common liquid chambers 1a. In this case, the partition wall between the common liquid chambers 1a has a predetermined thickness, for example, depending on the accuracy of processing and the strength of the frame 1.

If ease of ink flow from the common liquid chamber 1a to the nozzles 3a is different between the nozzles 3a (e.g., the ink flows at different rates), the liquid discharging performances of the nozzles 3a may be different from one another. To avoid this, the channels from the common liquid chamber 1a to the nozzles 3a (i.e., the openings 6d in the diaphragm 6 and the pressure chambers 22, the fluid restrictors 21, and the guide channels 23 in the channel plate 2) have the same shape. If channels from the common liquid chamber 1a to the nozzles 3a have the same shape as the shapes of the channels in the basic configuration of the liquid discharge head described with reference to FIGS. 1 to 5, the guide channels 23 formed in the channel plate 2 at the location at which the common liquid chambers 1a are separated may be apart from each other, as illustrated in FIG. 9A. Thus, the pressure chambers 22 at the location at which the common liquid chambers 1a are separated may also be away from each other. As a result, a nozzle pitch P2 at the location at which the common liquid chambers 1a are separated may increase. As a result, all the nozzle pitches are not equated with a narrow nozzle pitch P1, which may hinder high-resolution images.

If high-resolution images are unnecessary, all the nozzle pitches may be equated with the nozzle pitch P2 illustrated in FIG. 9A. In this case, a low-cost, elongated liquid discharge head can be provided. The present embodiment employs a configuration that will be described below to achieve the highly-dense arrangement of nozzles 3a and provide high-resolution images.

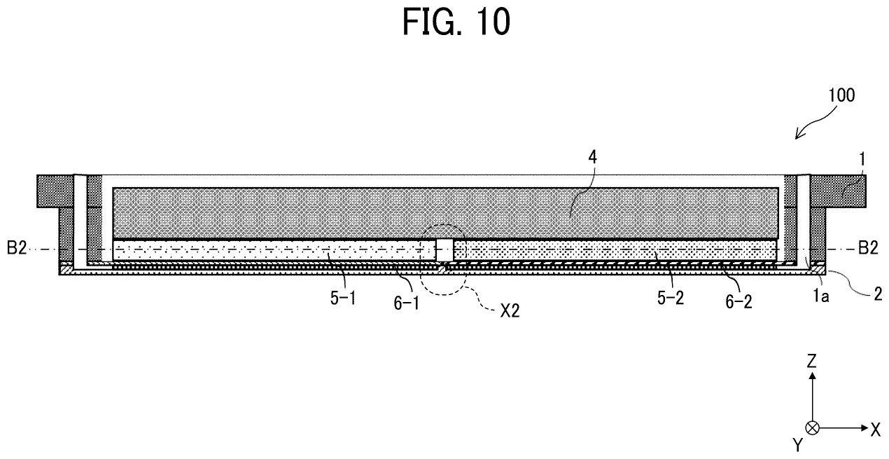

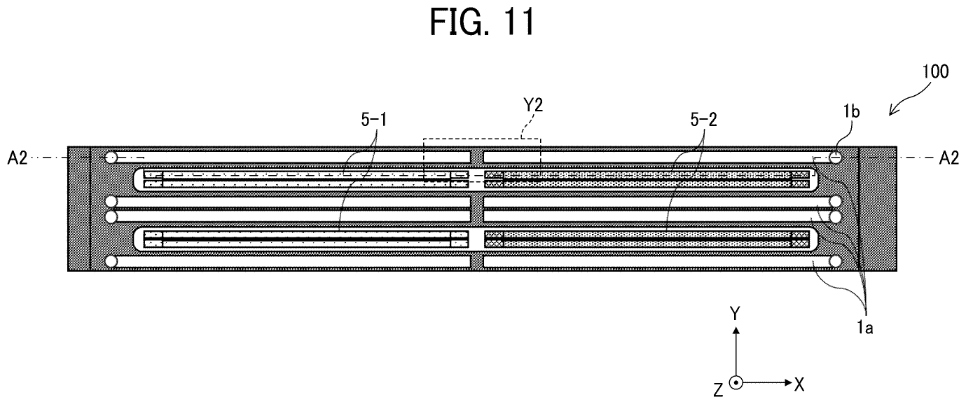

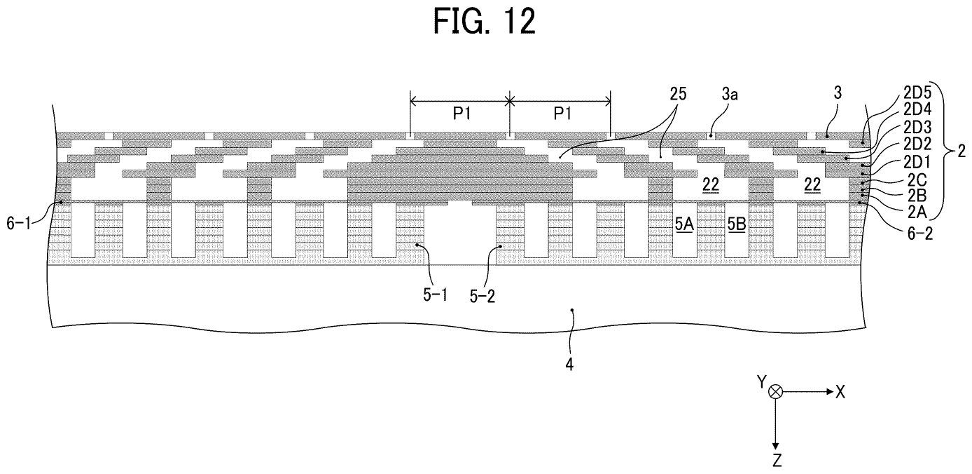

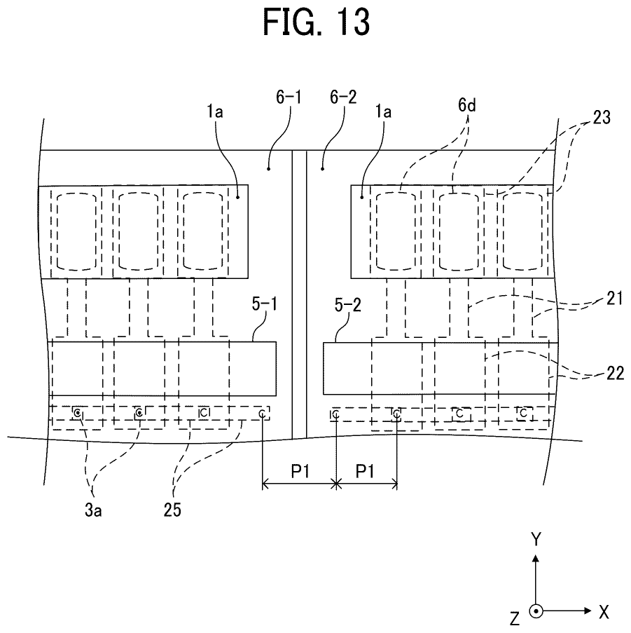

FIGS. 10 to 12 are schematic views of a liquid discharge head 100 according to an embodiment of the present disclosure. FIG. 10 is a cross-sectional view of the liquid discharge head 100 taken along line A2-A2 of FIG. 11. FIG. 11 is a cross-sectional view of the liquid discharge head 100 taken along line B2-B2 of FIG. 10. FIG. 12 is an enlarged view of the area surrounded by broken line X2 in FIG. 10. FIG. 13 is an enlarged view of the area surrounded by broken line Y2 in FIG. 11.

The liquid discharge head 100 includes two diaphragms 6 (6-1 and 6-2) arrayed side by side in the head longitudinal direction and two piezoelectric bodies 5-1 and 5-2 arrayed side by side in the head longitudinal direction. In other words, the diaphragm 6-1 is disposed adjacent to the diaphragm 6-2 in the longitudinal direction. Two common liquid chambers 1a are separated from each other at the center of the liquid discharge head 100 (nozzle face) in the head longitudinal direction, at which the diaphragms 6 (6-1 and 6-2) are separated. By arranging the two diaphragms 6 in the longitudinal direction in this manner, each diaphragm 6 can be shortened, so that the number of the diaphragms 6 to be obtained from a single wafer can be increased, as described above. Consequently, a decrease in the yield of the diaphragms 6 can be prevented, and thus the manufacturing cost of the liquid discharge head can be reduced. Moreover, the two piezoelectric bodies 5 (5-1 and 5-2) are arrayed side by side in the longitudinal direction, and thus each piezoelectric body 5 can be shortened. This configuration can reduce the difficulty in the accuracy of processing of a liquid discharge head, and an elongated liquid discharge head can be manufactured at low cost. Furthermore, the two common liquid chambers 1a are separated from each other at the center of the liquid discharge head 100 in the head longitudinal direction, at which the diaphragms 6 are separated. Accordingly, the ink can be prevented from leaking to the outside from the common liquid chamber 1a.

As illustrated in FIGS. 12 and 13, the liquid discharge head 100 includes communication pipes 25 connecting the pressure chambers 22 and the nozzles 3a corresponding to the pressure chambers 22, respectively. The communication pipes 25 may be referred to as communication channels. As illustrated in FIG. 12, each communication pipe 25 is inclined with respect to the nozzle face in the head longitudinal direction (X direction) such that an end of each communication pipe 25 on a nozzle side (i.e., a first end) is positioned closer to the center in the head longitudinal direction (X direction) than an end of each communication pipe 25 on a pressure chamber side (i.e., a second end), as viewed in the head transverse direction (Y direction). With such a configuration, the nozzle pitch can be prevented from increasing at the location at which the common liquid chambers 1a are separated. As illustrated in FIGS. 12 and 13, this configuration enables the ink channels from the common liquid chamber 1a to the nozzles 3a (i.e., the openings 6d in the diaphragm 6, the pressure chambers 22, the fluid restrictors 21, and the guide channels 23 in the channel plate 2) to have the same shape.

The above configuration, in which the nozzles 3a are arrayed at the narrow nozzle pitches P1, can provide high-resolution images. In addition, this configuration enables the ink channels from the common liquid chamber 1a to the nozzles 3a (i.e., the openings 6d in the diaphragm 6, the pressure chambers 22, the fluid restrictors 21, and the guide channels 23 in the channel plate 2) to have the same shape, and the nozzles 3a can have the same liquid discharging performance. Consequently, an elongated liquid discharge head can be provided at low cost with high resolution and good discharging performance.

As illustrated in FIG. 12, the liquid discharge head includes the channel plate 2 including multiple plate components 2D1 to 2D5 laminated one on another, which form the communication pipes 25 inclined with respect to the nozzle face in the head longitudinal direction (X direction) as viewed in the head transverse direction (Y direction). Specifically, through-holes are respectively formed in the plate components 2D1 to 2D5, which form respective portions of the communication pipe 25, and the through-holes are slightly shifted from one another in the head longitudinal direction (X direction) to form the communication pipes 25 inclined in the head longitudinal direction (X direction).

Due to such a configuration, the multiple plate components 2D1 to 2D5 are simply laminated one on another to form the communication pipes 25 extending in the head height direction (Z direction), or the discharge direction, and inclined in the head longitudinal direction (X direction) as viewed in the head transverse direction (Y direction). Such a configuration can easily form the communication pipes 25. In other words, the communication pipes 25 respectively extend from the multiple pressure chambers 22 to the multiple nozzles 3a in a direction inclined with respect to the discharge direction in a cross-section of the liquid discharge head 100 along a plane defined by the longitudinal direction and the discharge direction.

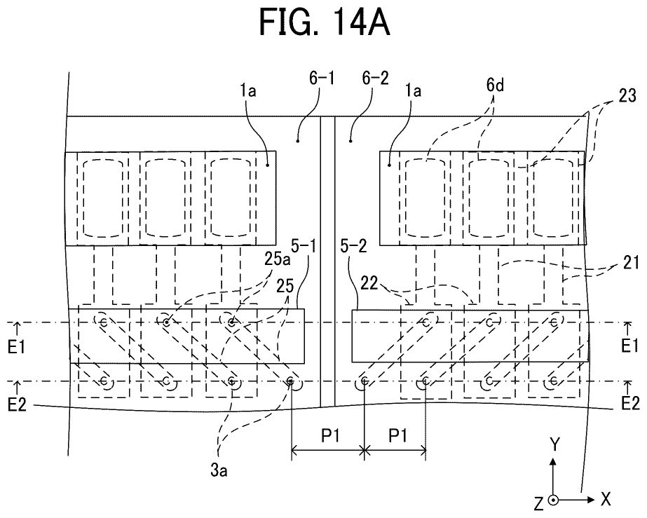

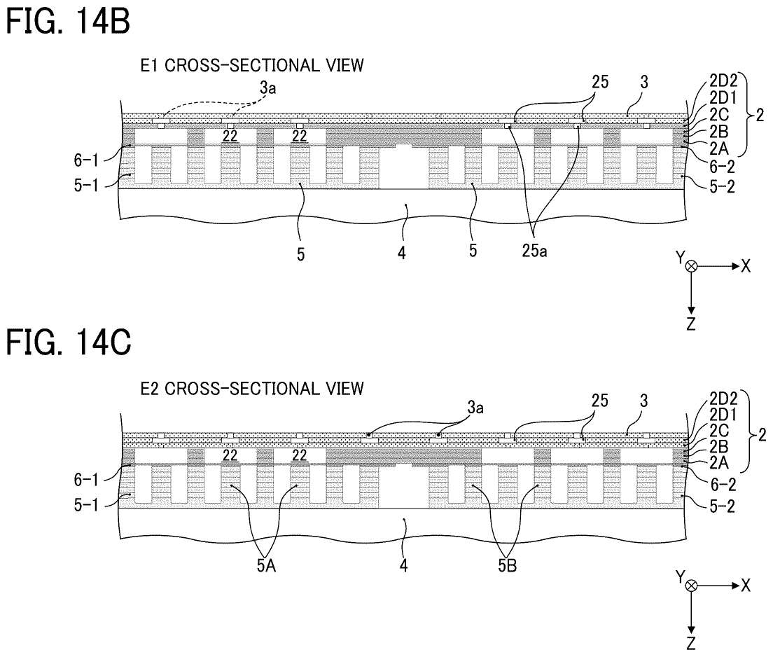

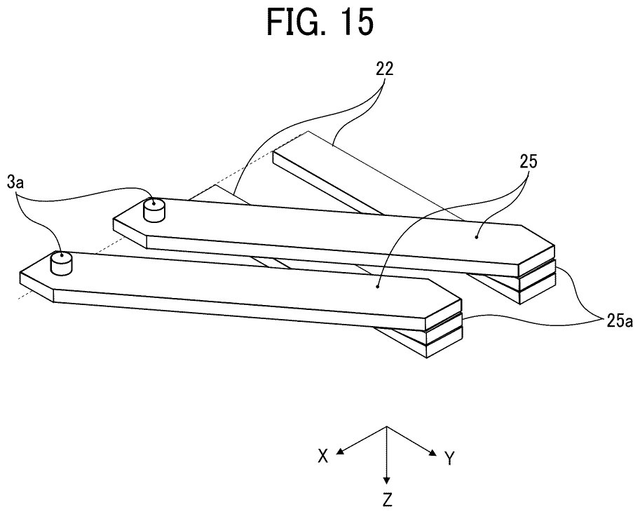

FIGS. 14A to 14C are diagrams each illustrating communication pipes 25 according to a modification. FIG. 15 is a perspective view of the ink channels from the pressure chambers 22 to the nozzles 3a in the modification.

In this modification, as illustrated in FIGS. 14A and 15, each communication pipe 25 extends in the head transverse direction (Y direction) and is inclined in the head longitudinal direction (X direction), as viewed in the head height direction (Z direction). In other words, each of the communication pipes 25 has a portion extending in a direction inclined with respect to both the head longitudinal direction and the head transverse direction. In still other wors, the communication pipes 25 are inclined with respect to the longitudinal direction on a plane of the channel plate 2. Each communication pipe 25 according to this modification is also inclined in the head longitudinal direction (X direction) such that an end of each communication pipe 25 on a nozzle side is positioned closer to the center in the head longitudinal direction (X direction) than an end of each communication pipe 25 on a pressure chamber side.

This modification can prevent the nozzle pitches from increasing at locations at which the common liquid chambers 1a are separated. Further, this configuration enables the channels from the common liquid chambers 1a to the nozzles 3a (i.e., the openings 6d in the diaphragm 6 and the pressure chambers 22, the fluid restrictors 21, and the guide channels 23 in the channel plate 2) to have the same shape. Accordingly, the configuration according to this modification enables the nozzles 3a to be arrayed at the narrow nozzle pitches P1 to provide high-resolution images. In addition, this configuration enables the ink channels from the common liquid chambers 1a to the nozzles 3a (i.e., the openings 6d in the diaphragm 6, the pressure chambers 22, the fluid restrictors 21, and the guide channels 23 in the channel plate 2) to have the same shape, and the nozzles 3a can have the same liquid discharging performance. Consequently, in the configuration according to this modification, an elongated liquid discharge head can be provided at low cost with high resolution and good discharging performance.

In this modification, as illustrated in FIGS. 14B and 14C, the channels from the pressure chambers 22 to the nozzles 3a can be formed with two plate components: the plate component 2D2 in which the communication pipes 25 are formed; and the plate component 2D1 having communication holes 25a via which the pressure chambers 22 communicate with the communication pipes 25. This configuration can form the channels from the pressure chambers 22 to the nozzles 3a with a smaller number of plate components than the configuration according to the above embodiment in which the communication pipes 25 are formed so as to extend in the head height direction (Z direction) and so as to be inclined in the head longitudinal direction (X direction) as viewed in the head transverse direction (Y direction). Accordingly, the number of components can be reduced to prevent the cost increase in the liquid discharge head. Furthermore, the height of the liquid discharge head can be prevented from increasing.

The communication pipes 25 may include a combination of communication pipes according to the above embodiment and the modification. More specifically, each communication pipe 25 may be inclined in the head longitudinal direction (X direction), as viewed in both the head transverse direction (Y direction) and the head height direction (Z direction).

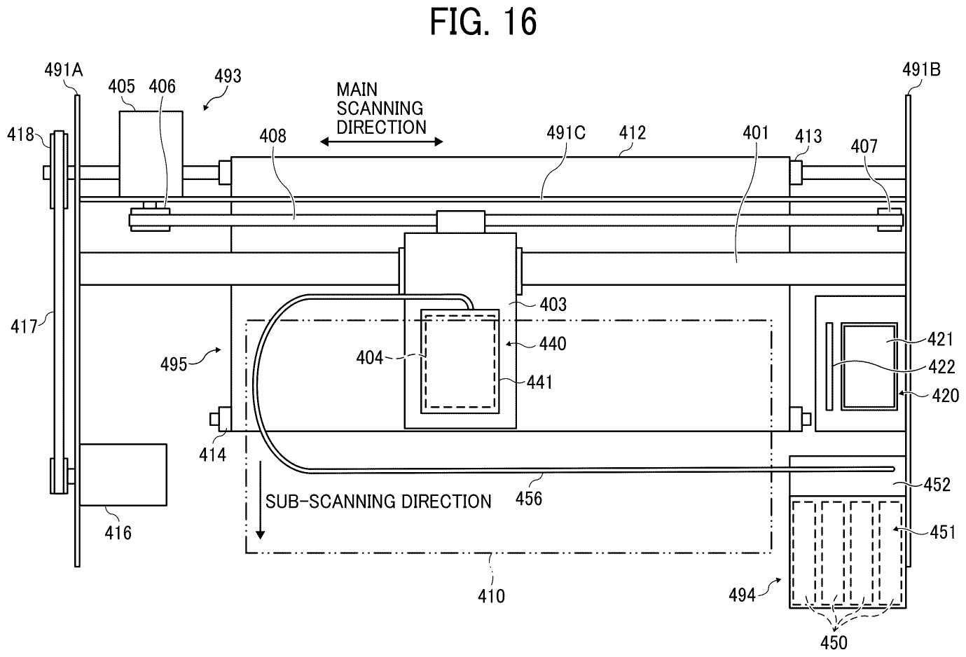

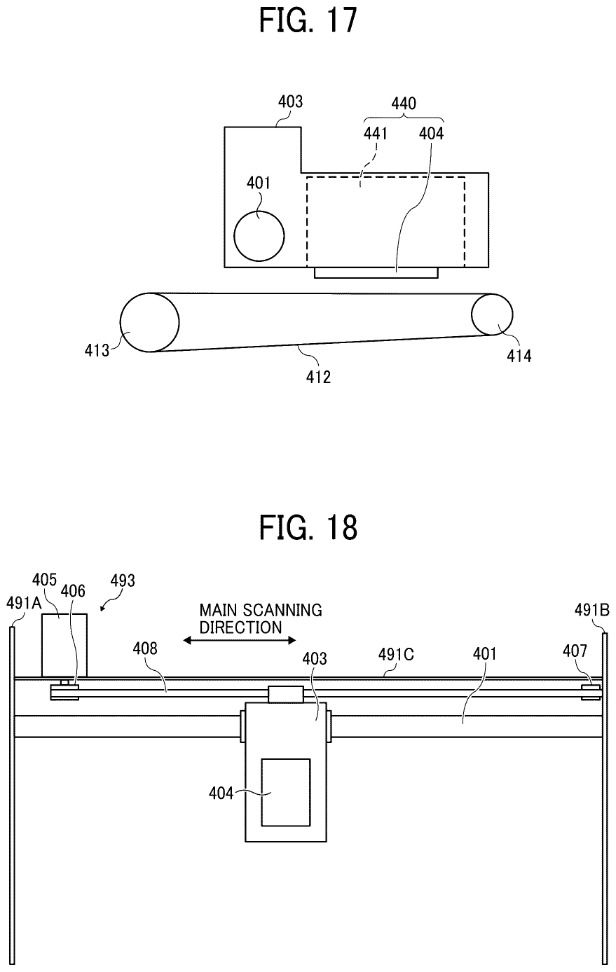

A liquid discharge apparatus including the liquid discharge head 100 described above is described below with reference to FIGS. 16 and 17. FIG. 16 is a plan view of a part of the liquid discharge apparatus. FIG. 17 is a side view of the part of the liquid discharge apparatus.

The liquid discharge apparatus is a serial-type apparatus in which a main-scanning moving mechanism 493 reciprocates a carriage 403 in a main scanning direction. The main-scanning moving mechanism 493 includes, for example, a guide 401, a main scanning motor 405, and a timing belt 408. The guide 401 is bridged between left and right side plates 491A and 491B to movably hold the carriage 403. The main scanning motor 405 reciprocates the carriage 403 in the main scanning direction via the timing belt 408 looped around a drive pulley 406 and a driven pulley 407.

The carriage 403 includes a liquid discharge unit 440 in which a liquid discharge head device 404 and a head tank 441 are integrated as a single unit. The liquid discharge head device 404 of the liquid discharge unit 440 includes recording units that discharge color liquids of, for example, yellow (Y), cyan (C), magenta (M), and black (K). In the liquid discharge head device 404, recording heads each having a nozzle array including multiple nozzles are arrayed in a staggered manner. The multiple nozzles are arrayed in the nozzle array direction, which is a sub-scanning direction (head longitudinal direction) orthogonal to the main scanning direction, and the recording heads discharge liquid downward in the discharge direction, similarly to the liquid discharge head 100 described above.

A supply mechanism 494 disposed outside the liquid discharge head device 404 supplies liquid stored in liquid cartridges 450 to the head tank 441 to supply the liquid to the liquid discharge head device 404. The supply mechanism 494 includes a cartridge holder 451 which is a loading device to mount the liquid cartridges 450, a tube 456, and a liquid feed unit 452 including a liquid feed pump. The liquid cartridge 450 is detachably mounted on the cartridge holder 451. The liquid feed unit 452 feeds the liquid from the liquid cartridge 450 to the head tank 441 via the tube 456.

The liquid discharge apparatus further includes a conveyance mechanism 495 to convey a sheet 410 (i.e., a medium). The conveyance mechanism 495 includes a conveyance belt 412 (i.e., a conveyor) and a sub-scanning motor 416 to drive the conveyance belt 412. The conveyance belt 412 attracts the sheet 410 and conveys the sheet 410 to a position facing the liquid discharge head device 404. The conveyance belt 412 is an endless belt looped around a conveyance roller 413 and a tension roller 414. The sheet 410 can be attracted to the conveyance belt 412 by, for example, electrostatic attraction or air suction. The conveyance belt 412 circumferentially moves in the sub-scanning direction as the conveyance roller 413 is rotationally driven by the sub-scanning motor 416 via a timing belt 417 and a timing pulley 418.

On one end of the range of movement of the carriage 403 in the main scanning direction, a maintenance mechanism 420 that maintains and recovers the liquid discharge head device 404 is disposed lateral to the conveyance belt 412. The maintenance mechanism 420 includes, for example, a cap 421 to cap the nozzle face (i.e., a face on which nozzles 4 are formed) of the liquid discharge head device 404 and a wiper 422 to wipe the nozzle face.

The main-scanning moving mechanism 493, the supply mechanism 494, the maintenance mechanism 420, and the conveyance mechanism 495 are mounted onto a housing including the side plates 491A and 491B and a back plate 491C.

In the liquid discharge apparatus having the above-described configuration, the sheet 410 is fed and attracted onto the conveyance belt 412 and conveyed in the sub-scanning direction as the conveyance belt 412 circumferentially moves. The liquid discharge head device 404 is driven in response to an image signal while the carriage 403 moves in the main scanning direction to discharge liquid onto the sheet 410 not in motion. As a result, an image is formed on the sheet 410.

As described above, the liquid discharge apparatus includes the liquid discharge head 100, thus allowing the stable formation of high-quality images.

Another liquid discharge unit is described below with reference to FIG. 18. FIG. 18 is a plan view of a part of the liquid discharge unit. The liquid discharge unit includes the housing, the main-scanning moving mechanism 493, the carriage 403, and the liquid discharge head device 404 among the components of the liquid discharge apparatus described above. The side plates 491A and 491B, and the back plate 491C construct the housing. The liquid discharge unit may further include at least one of the maintenance mechanism 420 or the supply mechanism 494, which may be attached to the side plate 491B.

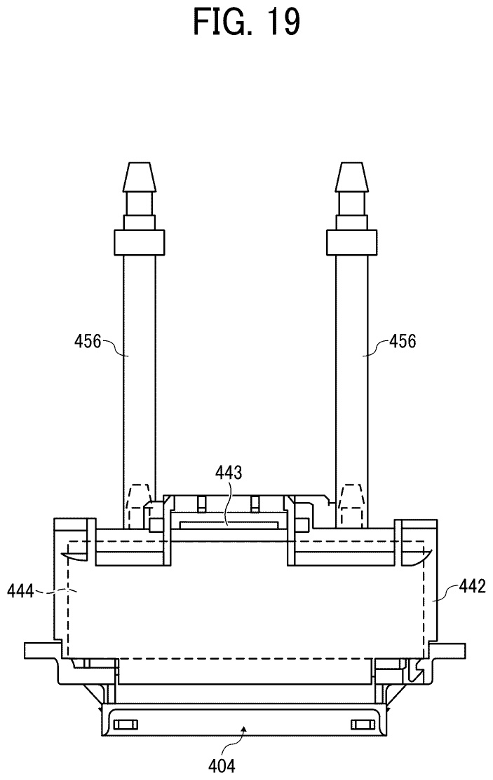

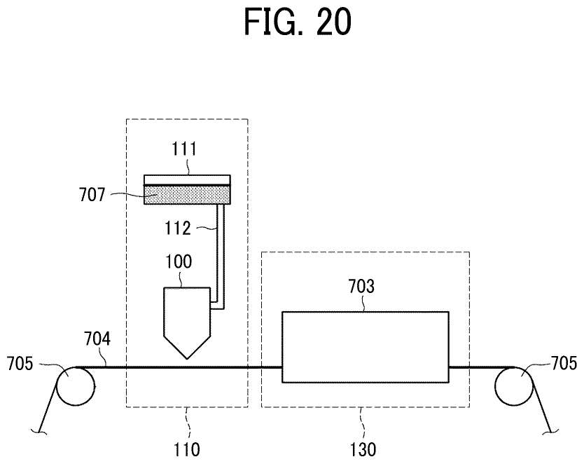

Yet another liquid discharge unit is described below with reference to FIG. 19. FIG. 19 is a front view of the liquid discharge unit. The liquid discharge unit includes the liquid discharge head device 404 to which a channel component 444 is attached, and tubes 456 connected to the channel component 444. The channel component 444 is disposed inside a cover 442. Alternatively, the liquid discharge unit may include the head tank 441 instead of the channel component 444. A connector 443 for electrically connecting to the liquid discharge head device 404 is disposed on an upper portion of the channel component 444.

In the above-described embodiments, the “liquid discharge apparatus” includes the liquid discharge head, the liquid discharge head device, or the liquid discharge unit and drives the liquid discharge head to discharge liquid.

The liquid discharge apparatus may be, for example, any apparatus that can discharge liquid to a medium onto which liquid can adhere or any apparatus to discharge liquid toward gas or into a different liquid.

The “liquid discharge apparatus” may further include devices relating to feeding, conveying, and ejecting of the medium onto which liquid can adhere and also include a pretreatment device and an aftertreatment device.

The “liquid discharge apparatus” may be, for example, an image forming apparatus to form an image on a sheet by discharging ink, or a three-dimensional fabrication apparatus to discharge fabrication liquid to a powder layer in which powder material is formed in layers, so as to form a three-dimensional object.

The “liquid discharge apparatus” is not limited to an apparatus that discharges liquid to visualize meaningful images such as letters or figures. For example, the discharge apparatus may be an apparatus that forms patterns having no meaning or an apparatus that fabricates three-dimensional images.

The above-described term “medium onto which liquid can adhere” represents a medium on which liquid is at least temporarily adhered, a medium on which liquid is adhered and fixed, or a medium into which liquid adheres and permeates. Specific examples of the “medium onto which liquid can adhere” include, but are not limited to, a recording material (medium) such as a paper sheet, recording paper, a recording sheet of paper, a film, or cloth, an electronic component such as an electronic substrate or a piezoelectric element, and a medium such as layered powder, an organ model, or a testing cell. The “medium onto which liquid can adhere” includes any medium to which liquid adheres, unless otherwise specified.

Examples of materials of the “medium onto which liquid can adhere” include any materials to which liquid can adhere even temporarily, such as paper, thread, fiber, fabric, leather, metal, plastic, glass, wood, ceramic, construction materials (e.g., wallpaper or floor material), and cloth textile.

Examples of the “liquid” include ink, treatment liquid, deoxyribonucleic acid (DNA) sample, resist, pattern material, binder, fabrication liquid, and solution or liquid dispersion containing amino acid, protein, or calcium.

The liquid discharge apparatus may be an apparatus to move the liquid discharge head and the medium onto which liquid can adhere relative to each other. However, the liquid discharge apparatus is not limited to such an apparatus. For example, the liquid discharge apparatus may be a serial head apparatus that moves the liquid discharge head or a line head apparatus that does not move the liquid discharge head.

Examples of the liquid discharge apparatus further include: a treatment liquid applying apparatus that discharges a treatment liquid onto a sheet to apply the treatment liquid to the surface of the sheet, for reforming the surface of the sheet; and an injection granulation apparatus that injects a composition liquid, in which a raw material is dispersed in a solution, through a nozzle to granulate fine particles of the raw material.

The liquid discharge apparatus may also include an apparatus for manufacturing an electrode and an electrochemical element that is also referred to as an electrode manufacturing apparatus. The electrode manufacturing apparatus is described below.

FIG. 20 is a schematic view of an electrode manufacturing apparatus. The electrode manufacturing apparatus is an apparatus for manufacturing an electrode including a layer containing an electrode material by discharging a liquid composition using a head module including a liquid discharge head.

A discharge device in the electrode manufacturing apparatus illustrated in FIG. 20 is the head module including the liquid discharge head 100 described above. The liquid discharge head 100 of the head module discharges a liquid composition. By so doing, the liquid composition is applied onto an object, and a liquid composition layer is formed on the object. The object, which may also be referred to as a discharge target in the following description, is not limited to any particular object and may be appropriately selected depending on the intended purpose, as long as the object is an object on which a layer containing an electrode material is to be formed. Examples of the object include an electrode substrate, i.e., a current collector, an active material layer, and a layer containing a solid electrode material. The object may be an electrode composite layer containing an active material on an electrode substrate, i.e., a current collector. The discharge device and a discharge process may be a device and a process of forming a layer containing an electrode material by directly discharging a liquid composition as long as the layer containing an electrode material can be formed on a discharge target. The discharge device and the discharge process may be a device and a process of forming a layer containing an electrode material by indirectly discharging a liquid composition.

Other configurations included in the electrode manufacturing apparatus for manufacturing an electrode composite layer are not limited to any particular configuration and may be appropriately selected depending on the intended purpose. Other processes included in the method for manufacturing an electrode composite layer are not limited to any particular process and may be appropriately selected depending on the intended purpose. For example, a heating device and a heating process are examples of the configuration and the process included in the electrode manufacturing apparatus and the manufacturing method of the electrode composite layer.

The heating device included the electrode manufacturing apparatus for manufacturing an electrode composite layer is a device that heats the liquid composition discharged by the discharge device. The heating process included in the manufacturing method for manufacturing an electrode composite layer is a process of heating the liquid composition discharged in the discharge process. The liquid composition is heated to dry the liquid composition layer.

As an example of the electrode manufacturing apparatus, an electrode manufacturing apparatus that forms an electrode composite layer containing an active material on an electrode substrate, i.e., a current collector, is described below.

As illustrated in FIG. 20, the electrode manufacturing apparatus includes a discharge process device 110 and a heating process device 130. The discharge process device 110 performs a discharge process of applying a liquid composition onto a print base material 704 having a discharge target to form a liquid composition layer. The heating process device 130 performs a heating process of heating the liquid composition layer to obtain an electrode composite layer.

The electrode manufacturing apparatus includes a conveyor 705 that conveys the print base material 704 (i.e., a medium). The conveyor 705 conveys the print base material 704 to the discharge process device 110 and the heating process device 130 in this order at a preset speed. A method of producing the print base material 704 having the discharge target such as an active material layer is not limited to any particular method, and a known method can be appropriately selected. The discharge process device 110 includes the liquid discharge head 100 that performs an application process of applying a liquid composition 707 onto the print base material 704, a storage container 111 that stores the liquid composition 707, and a supply tube 112 that supplies the liquid composition 707 stored in the storage container 111 to the liquid discharge head 100.

The discharge process device 110 discharges the liquid composition 707 from the liquid discharge head 100 so that the liquid composition 707 is applied onto the print base material 704 to form a liquid composition layer in a thin film shape. The storage container 111 may be integrated with the electrode manufacturing apparatus that forms the electrode composite layer or may be detachable from the electrode manufacturing apparatus. The storage container 111 may be a container additionally attachable to a container integrated with the electrode manufacturing apparatus for manufacturing the electrode composite layer or to a container detachable from the electrode manufacturing apparatus for manufacturing the electrode composite layer. The storage container 111 that stably stores the liquid composition 707 and the supply tube 112 that stably supplies the liquid composition 707 can be used.

The heating process device 130 performs a solvent removal process of heating and removing the solvent remaining in the liquid composition layer. Specifically, the solvent that remains in the liquid composition layer is heated and dried by a heater 703 of the heating process device 130. Accordingly, the solvent is removed from the liquid composition layer. Thus, the electrode composite layer is formed. The heating process device 130 may perform the solvent removal process under reduced pressure.

The heater 703 is not limited to any particular heater and may be appropriately selected depending on the intended purpose. For example, the heater 703 may be a substrate heater, an infrared (IR) heater, or a hot air heater. The heater 703 may be a combination of at least two of the substrate heater, the IR heater, and the hot air heater. A heating temperature and heating time can be appropriately selected according to the boiling point of the solvent contained in the liquid composition 707 or the thickness of a formed film.

The electrode manufacturing apparatus according to the present embodiment is used to discharge the liquid composition to a desired position on the discharge target. The electrode composite layer can be suitably used, for example, as a part of the configuration of an electrochemical element. The configuration of the electrochemical element other than the electrode composite layer is not limited to any particular configuration, and a known configuration can be appropriately selected. Examples of the configuration other than the electrode composite layer include a positive electrode, a negative electrode, and a separator.

The “liquid discharge unit” refers to a liquid discharge head integrated with functional components or mechanisms, i.e., an assembly of components related to liquid discharge. For example, the “liquid discharge unit” includes a combination of the liquid discharge head with at least one of a head tank, a carriage, a supply mechanism, a maintenance mechanism, or a main-scanning moving mechanism.

The above integration may be achieved by, for example, a combination in which the liquid discharge head and a functional component(s) or mechanism(s) are fixed to each other through, e.g., fastening, bonding, or engaging, and a combination in which one of the liquid discharge head and the functional component(s) or mechanism(s) is movably held to the other. The liquid discharge head and the functional component(s) or mechanism(s) may be detachably attached to each other.

Examples of the liquid discharge unit include the liquid discharge unit 440 in which a head module (liquid discharge head) and a head tank are integrated, as illustrated in FIG. 18. Alternatively, the liquid discharge head and the head tank coupled (connected) to each other via, for example, a tube may form the liquid discharge unit as a single unit. A unit including a filter may further be added to a portion between the head tank and the liquid discharge head of the liquid discharge unit.

In another example, the liquid discharge unit may be an integrated unit in which a liquid discharge head is integrated with a carriage.

As yet another example, the liquid discharge unit is a unit in which the liquid discharge head and the main-scanning moving mechanism are combined into a single unit. The liquid discharge head is movably held by a guide that is a part of the main-scanning moving mechanism. Like the liquid discharge unit illustrated in FIG. 17, the liquid discharge head, the carriage, and the main-scanning moving mechanism may form the liquid discharge unit as a single unit.

In another example, the cap that forms a part of the maintenance mechanism is fixed to the carriage mounting the liquid discharge head so that the liquid discharge head, the carriage, and the maintenance mechanism are integrated as a single unit to form the liquid discharge unit.

Further, in still another example, the liquid discharge unit includes tubes connected to the liquid discharge head to which the head tank or the channel component is attached so that the liquid discharge head and the supply mechanism are integrated as a single unit, as illustrated in FIG. 19.

The main-scanning moving mechanism may be a guide only. The supply mechanism may be a tube(s) only or a loading device only.

The actuator element used in the liquid discharge head is not limited to a particular type of pressure generator. The pressure generator is not limited to the piezoelectric element (or a laminated piezoelectric element) described in the above-described embodiments, and may be, for example, a thermal actuator that employs an electrothermal transducer element, such as a thermal resistor, or an electrostatic actuator including a diaphragm and opposed electrodes.

In the present specification, the terms “image formation,” “recording,” “printing,” “image printing,” and “fabricating” used herein may be used synonymously with each other.

The embodiments described above are presented as examples and are not intended to limit the scope of the present disclosure. The above-described novel embodiments can be implemented in other various forms, and various omissions, replacements, and changes can be made without departing from the scope of the disclosure. These embodiments and modifications or variations thereof are included in the scope and gist of the present disclosure, and are included in the scope of claims and the equivalent scope thereof.

The embodiments described above are just examples, and the various aspects of the present disclosure attain respective effects as follows.

### Aspect 1

According to Aspect 1, a liquid discharge head includes: multiple nozzles 3a arrayed in a head longitudinal direction (X direction); multiple pressure chambers 22 communicating with the respective nozzles 3a; multiple diaphragms 6 forming wall portions of the multiple pressure chambers 22; and an actuator element, such as a piezoelectric body 5, that drives the diaphragms 6. The diaphragms 6 are arrayed side by side in the head longitudinal direction.

In other words, a liquid discharge head includes a nozzle plate, a channel plate, multiple diaphragms, and an actuator element. The nozzle plate has multiple nozzles arrayed on a nozzle face in a longitudinal direction of the nozzle face. The multiple nozzles discharge a liquid in a discharge direction perpendicular to the nozzle face. The channel plate is disposed over the nozzle plate in the discharge direction. The channel plate has multiple pressure chambers respectively communicating with the multiple nozzles. The multiple diaphragms are disposed over the channel plate in the discharge direction. The multiple diaphragms respectively define wall portions of the multiple pressure chambers. The multiple diaphragms are arrayed in the longitudinal direction. The actuator element is disposed over the multiple diaphragms to vibrate the multiple diaphragms.

As illustrated in FIG. 7, the diaphragms 6 are obtained by cutting the wafer into rectangular shapes. When the diaphragms are elongated for the elongated liquid discharge head, the number of diaphragms to be obtained from a single wafer decreases. When diaphragms are elongated, the number of defective diaphragms may increase, causing a low yield. As a result, the manufacturing cost may increase.

However, the configuration of Aspect 1, in which the multiple diaphragms are arrayed in the head longitudinal direction, can achieve an elongated liquid discharge head without elongated diaphragm. When the diaphragms can be prevented from being elongated, as illustrated in FIG. 8, the number of the diaphragms 6 to be obtained from a single wafer can be increased.

In addition, the number of defective diaphragms 6 can be reduced, and thus the yield can be increased. Consequently, the manufacturing cost of the diaphragms 6 can be reduced, and thus the manufacturing cost of an elongated liquid discharge head can be reduced.

### Aspect 2

According to Aspect 2, in the liquid discharge head of Aspect 1, the diaphragms 6 include two diaphragms 6. The two diaphragms 6 are arrayed side by side in the head longitudinal direction (X direction). The pressure chambers 22 are connected to the corresponding nozzles 3a via communication pipes 25. Each of the communication pipes 25 is inclined in the head longitudinal direction.

In other words, the liquid discharge head according to Aspect 1, further includes communication channels (e.g., the communication pipes 25) respectively connect the multiple pressure chambers and the multiple nozzles. The multiple pressure chambers include first multiple pressure chambers and second multiple pressure chambers adjacent to the first multiple pressure chambers in the longitudinal direction. The multiple diaphragms include a first diaphragm facing the first multiple pressure chambers, and a second diaphragm adjacent to the first diaphragm in the longitudinal direction and facing the second multiple pressure chambers. The communication channels are inclined with respect to the longitudinal direction on a plane of the channel plate.

As described in the above embodiment, the diaphragms 6 typically extend in the head longitudinal direction to form a part of wall faces or bottom faces of common liquid chambers 1a from which liquid, such as ink, is supplied to each pressure chamber 22. In addition, the nozzles 3a are typically formed directly below the respective pressure chambers 22. Even when multiple diaphragms 6 are seamlessly arrayed side by side in the head longitudinal direction (X direction), liquid, such as ink, inside the common liquid chamber may leak to the outside via a gap between the diaphragms 6. For this reason, the common liquid chamber 1a is divided into multiple common liquid chambers at a location at which the diaphragms 6 are separated. Similarly to the diaphragms 6, the common liquid chambers 1a are arrayed side by side in the head longitudinal direction (X direction).

The partition wall between the common liquid chambers 1a has a predetermined thickness for the accuracy of processing and the strength. If the pressure chamber 22 is positioned at the same location as the partition wall in the head longitudinal direction (X direction), ease of liquid flow from the common liquid chamber 1a to this pressure chamber 22 is different from ease of liquid flow from the common liquid chamber 1a to another pressure chamber 22 positioned at the location at which the common liquid chamber 1a is positioned in the head longitudinal direction (e.g., the liquid flows at different rates at the locations). In this case, the performance of discharging the liquid from the nozzle 3a communicating with the pressure chamber 22 at the location of the partition wall between the common liquid chambers 1a may be different from the performance of discharging the liquid from the nozzle communicating with the another pressure chamber 22 in the head longitudinal direction.

For this reason, the pressure chamber 22 is not arrayed at the location, in the head longitudinal direction, of the partition wall between the common liquid chambers 1a. Thus, the distance between the pressure chambers across this partition wall is equal to or more than the thickness of the partition wall. As a result, the nozzles communicating with the pressure chambers closest to the partition wall are apart from each other in the head longitudinal direction. If other nozzle pitches are equated with the pitch between these nozzles, liquid droplets may land at locations apart from one another on a medium, such as a recording sheet. Accordingly, high-resolution images are not formed.

In Aspect 2, however, the communication pipes 25 connecting the pressure chambers 22 and the respective nozzles 3a are provided. In addition, each communication pipe 25 is inclined in the head longitudinal direction. By inclining the communication pipes 25 in the head longitudinal direction, the nozzles 3a can be shifted in the head longitudinal direction from the corresponding pressure chambers 22.

With this configuration, as described with reference to FIG. 12 and some other drawings, the pressure chambers 22 closest to the partition wall between the common liquid chambers 1a can be arrayed at the locations of the common liquid chambers 1a in the head longitudinal direction. In addition, the nozzles 3a communicating with these pressure chambers 22 can be arrayed at the location of the partition wall.

As a result, the nozzle pitch can be narrower than the thickness of the partition wall. This configuration can shorten the distance between liquid droplets landed onto a medium, such as a recording sheet, to form high-resolution images.

Moreover, each pressure chamber 22 can be arrayed at a location at which a corresponding common liquid chamber 1a is disposed in the head longitudinal direction. Thus, the channels from the common liquid chamber 1a to the pressure chambers 22 can be the same, so that the ease of liquid flow from the common liquid chamber 1a to the pressure chambers 22 can be the same (e.g., the liquid flows at the same rate). Furthermore, the communication pipes 25 having the same shape allow liquid to flow in the same manner from the pressure chambers 22 to the nozzles 3a (e.g., the liquid flows at the same rate). Consequently, liquid can be discharged from each nozzle 3a with the same liquid discharging performance.

### Aspect 3

According to Aspect 3, in the liquid discharge head of Aspect 2, the two diaphragms 6 are separated from each other at a center of the liquid discharge head 100 in the head longitudinal direction. Each communication pipe 25 is inclined such that an end of each communication pipe 25 on a nozzle side is positioned closer to the center in the head longitudinal direction than an end of each communication pipe 25 on a pressure chamber side.

In other words, in the liquid discharge head according to Aspect 2 or 4, the first diaphragm and the second diaphragm are separated at a center of the nozzle face in the longitudinal direction. Each of the communication channels has a first end connected to a corresponding nozzle of the multiple nozzles and a second end connected to a corresponding pressure chamber of the multiple pressure chambers. The first end is closer to the center of the nozzle face than the second end in the longitudinal direction.

### Aspect 4

According to Aspect 4, in the liquid discharge head of Aspect 2 or 3, each communication pipe 25 has a predetermined length in a liquid discharge direction (Z direction), such as a head height direction, and is inclined in the head longitudinal direction (X direction) as viewed in a head transverse direction (Y direction).

In other words, the liquid discharge head according to Aspect 1, further includes communication channels respectively connect the multiple pressure chambers and the multiple nozzles. The multiple pressure chambers include first multiple pressure chambers and second multiple pressure chambers adjacent to the first multiple pressure chambers in the longitudinal direction. The multiple diaphragms include a first diaphragm facing the first multiple pressure chambers, and a second diaphragm adjacent to the first diaphragm in the longitudinal direction and facing the second multiple pressure chambers. The communication channels respectively extend from the multiple pressure chambers to the multiple nozzles in a direction inclined with respect to the discharge direction in a cross-section of the liquid discharge head along a plane defined by the longitudinal direction and the discharge direction.

### Aspect 5

According to Aspect 5, in the liquid discharge head of Aspect 4, the communication pipes 25 are formed by laminating multiple plate components 2D1 to 2D5. The communication pipes 25 inclined in the head longitudinal direction (X direction) as viewed in the head transverse direction (Y direction) are formed by forming through-holes so as to be shifted from one another in the head longitudinal direction (X direction). The through-holes form portions of the communication pipes 25 in the respective plate components 2D1 to 2D5.

In other words, the channel plate includes multiple plate components each having through-holes defining a part of the communication channels. The multiple plate components are laminated one on another with the through-holes shifted from each other in the longitudinal direction to form the communication channels inclined with respect to the discharge direction.

With this configuration, as described in the above embodiment, the communication pipes 25 can easily be inclined in the head longitudinal direction (X direction) as viewed in the head transverse direction (Y direction).

### Aspect 6

According to Aspect 6, in the liquid discharge head of any one of Aspects 2 to 5, each communication pipe 25 has a portion extending in a head transverse direction (Y direction). The portion of each communication pipe 25 extending in the head transverse direction is inclined in the head longitudinal direction (X direction) as viewed in a liquid discharge direction (Z direction), or a head height direction.

In other words, each of the communication channels has a portion extending in a direction inclined with respect to both the longitudinal direction and a transverse direction orthogonal to the longitudinal direction.

With this configuration, as described with reference to FIGS. 14A to 14C and 15, the number of the plate components for forming the communication pipes 25 can be reduced. Thus, the number of components can be reduced to reduce the cost of the liquid discharge head. Moreover, the height of the liquid discharge head can be lowered.

### Aspect 7

According to Aspect 7, the liquid discharge head of any one of Aspects 1 to 6 further includes multiple common liquid chambers 1a communicating with the multiple pressure chambers 22. The diaphragms 6 form at least portions of wall faces or bottom faces of the common liquid chambers 1a. The common liquid chambers 1a are separated from one another at a location at which the two diaphragms 6 are separated in the head longitudinal direction.

In other words, the liquid discharge head according to any one of Aspects 1 to 6, further includes a frame having a common liquid chamber communicating with the multiple pressure chambers. The multiple diaphragms define at least a part of a wall face or a bottom face of the common liquid chamber. The common liquid chamber is divided at a center of the nozzle face at which the multiple diaphragms are separated in the longitudinal direction.

### Aspect 8

According to Aspect 8, in the liquid discharge head of any one of Aspects 1 to 7, the actuator element, such as the piezoelectric body 5, includes multiple actuator elements. The multiple actuator elements are arrayed side by side in the head longitudinal direction.

In other words, the liquid discharge head according to any one of Aspects 1 to 7, further includes multiple actuator elements including the actuator element. The multiple actuator elements are arrayed in the longitudinal direction. The multiple actuator elements respectively vibrate the multiple diaphragms.

With this configuration, the liquid discharge head can be elongated without elongating the actuator element, such as the piezoelectric body 5. Consequently, the difficulty in processing the liquid discharge head with high accuracy can be lowered to reduce the manufacturing cost.

### Aspect 9

According to Aspect 9, a liquid discharge apparatus includes a liquid discharge head 100. As the liquid discharge head 100, the liquid discharge head of any one of Aspects 1 to 8 is used.

In other words, a liquid discharge apparatus includes the liquid discharge head according to any one of Aspects 1 to 8, to discharge a liquid onto a medium and a conveyor to convey the medium to the liquid discharge head.

With this configuration, the cost of the liquid discharge apparatus can be reduced.

As described above, according to one aspect of the present disclosure, the manufacturing cost of an elongated liquid discharge head can be reduced.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A liquid discharge head comprising:
a nozzle plate having multiple nozzles arrayed on a nozzle face in a longitudinal direction of the nozzle face,
the multiple nozzles to discharge a liquid in a discharge direction perpendicular to the nozzle face;
a channel plate over the nozzle plate in the discharge direction,
the channel plate having multiple pressure chambers respectively communicating with the multiple nozzles;
multiple diaphragms over the channel plate in the discharge direction,
the multiple diaphragms respectively defining wall portions of the multiple pressure chambers, and
the multiple diaphragms arrayed in the longitudinal direction; and
an actuator element over the multiple diaphragms to vibrate the multiple diaphragms.

2. The liquid discharge head according to claim 1, further comprising communication channels respectively connect the multiple pressure chambers and the multiple nozzles,
wherein the multiple pressure chambers include:
first multiple pressure chambers; and
second multiple pressure chambers adjacent to the first multiple pressure chambers in the longitudinal direction,
the multiple diaphragms include:
a first diaphragm facing the first multiple pressure chambers; and
a second diaphragm adjacent to the first diaphragm in the longitudinal direction and facing the second multiple pressure chambers, and
the communication channels are inclined with respect to the longitudinal direction on a plane of the channel plate.

3. The liquid discharge head according to claim 2,
wherein the first diaphragm and the second diaphragm are separated at a center of the nozzle face in the longitudinal direction,
each of the communication channels has:
a first end connected to a corresponding nozzle of the multiple nozzles; and
a second end connected to a corresponding pressure chamber of the multiple pressure chambers, and
the first end is closer to the center of the nozzle face than the second end in the longitudinal direction.

4. The liquid discharge head according to claim 1, further comprising communication channels respectively connect the multiple pressure chambers and the multiple nozzles,
wherein the multiple pressure chambers include:
first multiple pressure chambers; and
second multiple pressure chambers adjacent to the first multiple pressure chambers in the longitudinal direction,
the multiple diaphragms include:
a first diaphragm facing the first multiple pressure chambers; and
a second diaphragm adjacent to the first diaphragm in the longitudinal direction and facing the second multiple pressure chambers, and
the communication channels respectively extend from the multiple pressure chambers to the multiple nozzles in a direction inclined with respect to the discharge direction in a cross-section of the liquid discharge head along a plane defined by the longitudinal direction and the discharge direction.

5. The liquid discharge head according to claim 4,
wherein the first diaphragm and the second diaphragm are separated at a center of the nozzle face in the longitudinal direction,
each of the communication channels has:
a first end connected to a corresponding nozzle of the multiple nozzles; and
a second end connected to a corresponding pressure chamber of the multiple pressure chambers, and
the first end is closer to the center of the nozzle face than the second end in the longitudinal direction.

6. The liquid discharge head according to claim 4,
wherein the channel plate includes multiple plate components each having through-holes defining a part of the communication channels, and
the multiple plate components are laminated one on another with the through-holes shifted from each other in the longitudinal direction to form the communication channels inclined with respect to the discharge direction.

7. The liquid discharge head according to claim 2,
wherein each of the communication channels has a portion extending in a direction inclined with respect to both the longitudinal direction and a transverse direction orthogonal to the longitudinal direction.

8. The liquid discharge head according to claim 1, further comprising a frame having a common liquid chamber communicating with the multiple pressure chambers,
wherein the multiple diaphragms define at least a part of a wall face or a bottom face of the common liquid chamber, and
the common liquid chamber is divided at a center of the nozzle face at which the multiple diaphragms are separated in the longitudinal direction.

9. The liquid discharge head according to claim 1, further comprising multiple actuator elements including the actuator element,
wherein the multiple actuator elements are arrayed in the longitudinal direction, and
the multiple actuator elements respectively vibrate the multiple diaphragms.

10. A liquid discharge apparatus comprising:
the liquid discharge head according to claim 1, to discharge a liquid onto a medium; and
a conveyor to convey the medium to the liquid discharge head.
